(19) United States
(12) Patent Application Publication
(10) Pub. No.: US 2026/0082349 A1
(43) Pub. Date: Mar. 19, 2026

(54) WIRELESS COMMUNICATION REGISTRATION AREA ALLOCATION AND UPDATE

(71) Applicant: InterDigital Patent Holdings, Inc., Wilmington, DE (US)

(72) Inventors: Mohamad Kenan Al-Hares, Canterbury (GB); Michael Starsinic, Newtown, PA (US); Michel Roy, Candiac (CA); Ulises Olvera-Hernandez, Saint-Lazare (CA); Rocco Di Girolamo, Laval, CA (US); Samir Ferdi, Kirkland (CA); Saad Ahmad, Montreal (CA); Zhibi Wang, Woodridge, IL (US); Robert Gazda, Spring City, PA (US)

(73) Assignee: InterDigital Patent Holdings, Inc., Wilmington, DE (US)

(21) Appl. No.: 18/884,731

(22) Filed: Sep. 13, 2024

(51) Int. Cl. H04W 60/00; H04W 8/02

(52) U.S. Cl. CPC H04W 60/00; H04W 8/02

(57) ABSTRACT

A wireless transmit/receive unit (WTRU) transmits a first request message including indication information indicating that the WTRU supports receiving a registration area (RA) set. The WTRU receives a first response message including RA set information, including information about two or more RAs within an RA set. Also, the WTRU detects that the WTRU has moved from a first tracking area to a second tracking area. In addition, the WTRU determines that the first tracking area and the second tracking area are both part of the RA set, and that the first tracking area and the second tracking area are parts of different RAs. The WTRU transmits, based on the determination, a second request message. Moreover, the WTRU receives a second response message.

### BACKGROUND

In wireless communication, a registration area is a logical concept which indicates a geographical area where a handset, such as a user equipment (UE) or wireless transmit/receive unit (WTRU) can move without the need to perform a registration update a network. The registration area consists of one or more tracking areas (TA). When a WTRU registers with the network over a 3rd Generation Partnership Project (3GPP) access, an Access and Mobility Management Function (AMF) allocates a single Registration Area to the WTRU. The AMF sends the Registration Area information to the WTRU. The Registration Area information is a list of tracking areas for the WTRU. The list of tracking areas is a tracking area identity (TAI) list.

A tracking is a logical concept where WTRU can move without updating the network about its location. The TAI is constructed from the Mobile Country Code (MCC), Mobile Network Code (MNC) and Tracking Area Code (TAC). One or more base stations can be part of the same tracking area. Each base station this is part of the same tracking area broadcasts the same TAI.

### SUMMARY

A wireless transmit/receive unit (WTRU) transmits a first request message including indication information indicating that the WTRU supports receiving a registration area (RA) set. Further, the WTRU receives a first response message including RA set information, including information about two or more RAs within an RA set. In an example, each RA is associated with one or more tracking areas and a probability value. Additionally or alternatively, each tracking area is associated with a tracking area identity.

Also, the WTRU detects that the WTRU has moved from a first tracking area to a second tracking area. In addition, the WTRU determines that the first tracking area and the second tracking area are both part of the RA set, and that the first tracking area and the second tracking area are parts of different RAs. Further, the WTRU may also include in the determination that the second tracking area is part of an RA that is associated with a probability value that is less than a threshold.

The WTRU transmits, based on the determination, a second request message. Moreover, the WTRU receives a second response message.

Additionally or alternatively, each RA is associated with an RA Identity. Additionally or alternatively, the threshold is received from a network in a broadcast message.

Additionally or alternatively, the second request message is transmitted based on a further determination that the second tracking area is associated with a power mode setting of the WTRU. Additionally or alternatively, the second request message is transmitted based on a further determination that the second tracking area is associated with a discontinuous reception (DRX) cycle size configuration of the WTRU.

Additionally or alternatively, the second request message is transmitted based on a further determination that the second tracking area is associated with an RA identity that is broadcast by the network. Additionally or alternatively, the second request message is transmitted based on a further determination that the second tracking area is not associated with an RA identity that is broadcast by the network.

Additionally or alternatively, the second request message is transmitted based on a further determination that second tracking area is associated with a probability value that is broadcast by the network. Additionally or alternatively, the second request message is transmitted based on a further determination that policy information received by the WTRU indicates that the WTRU should trigger a mobility registration update when the WTRU moves to the second tracking area. Additionally or alternatively, the first request message is a non-access-stratum mobility management (NAS-MM) message

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example procedure of a WTRU configured and triggered to update a registration area (RA) set and a network response; and

FIG. 3 is a flowchart diagram illustrating an example procedure of a WTRU updating an RA set and a network response.

### DETAILED DESCRIPTION

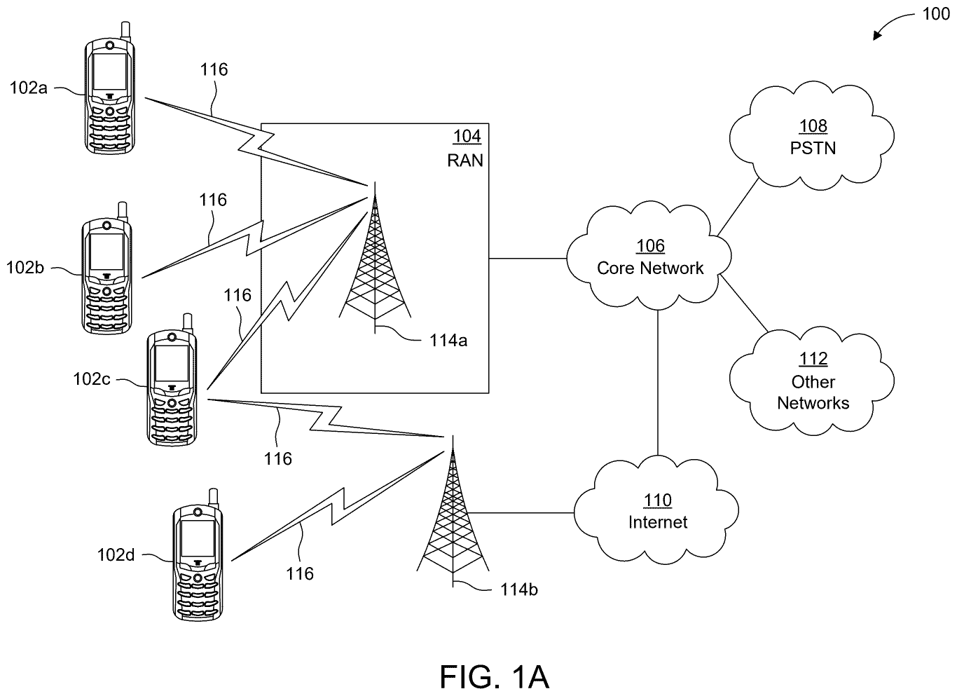

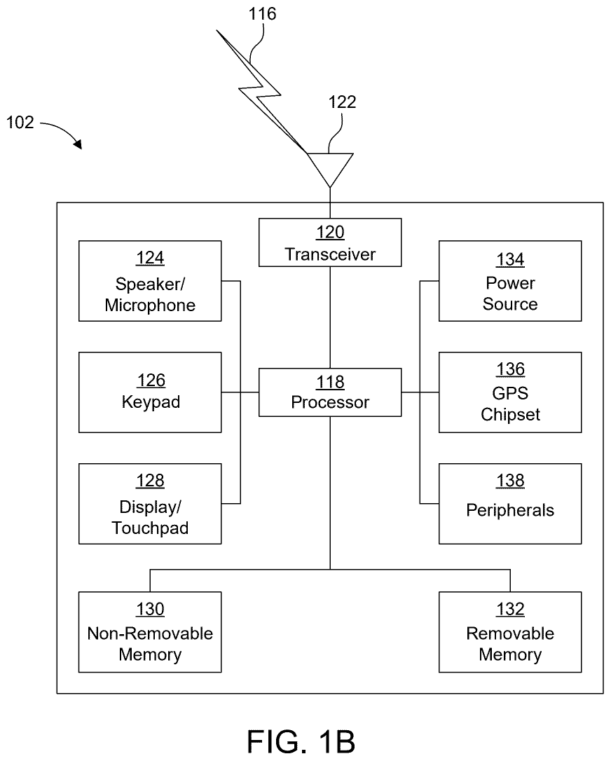

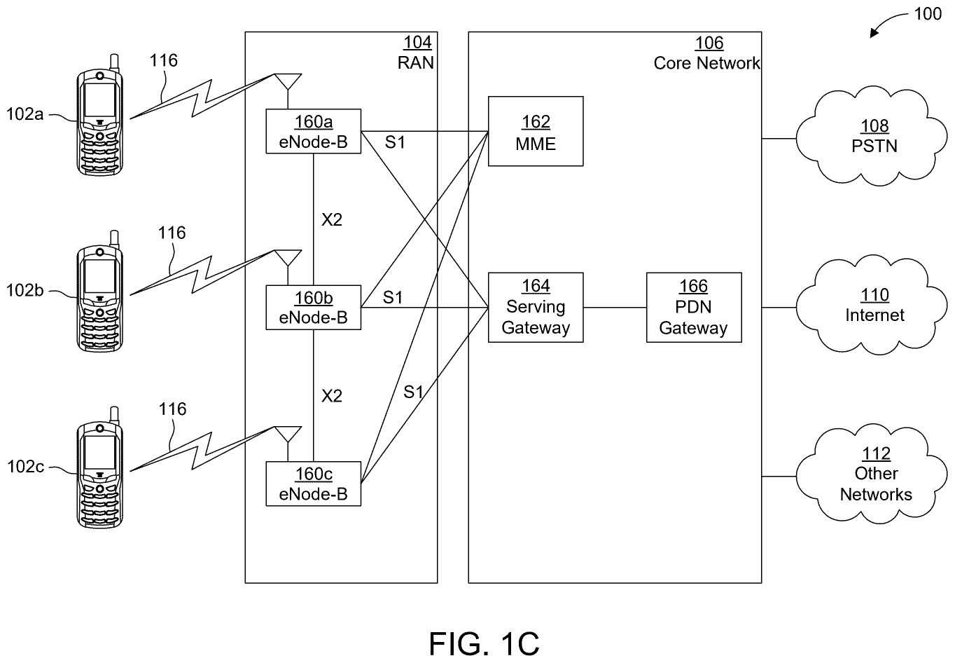

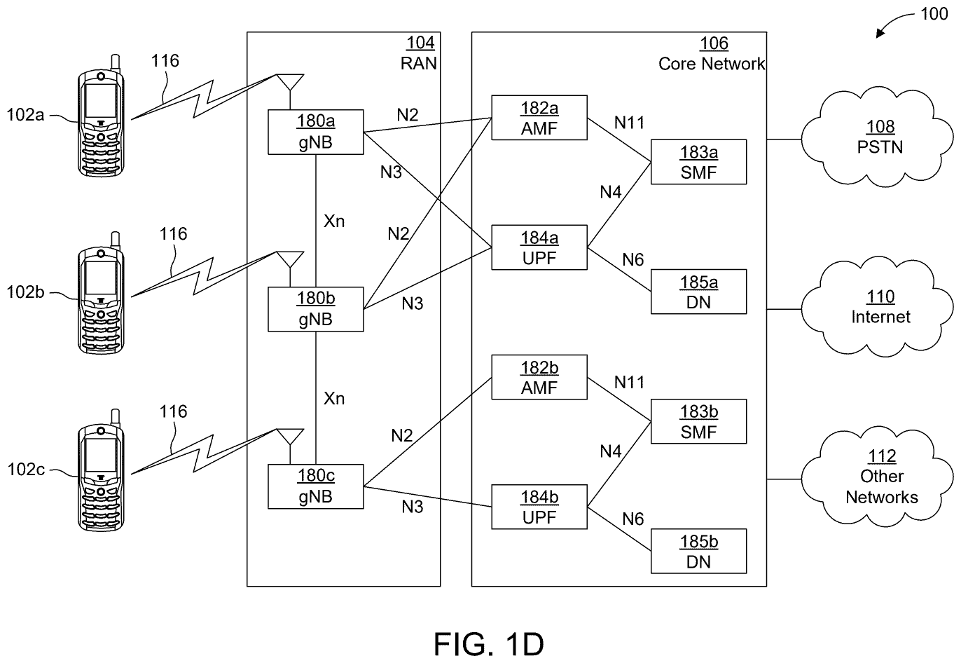

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3rd Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As noted, a registration area is a logical concept which indicates a geographical area where a handset, such as a UE or WTRU can move without the need to perform a registration update a network. The registration area consists of one or more tracking areas (TAs). When a WTRU registers with the network over a 3GPP access, an AMF allocates a single Registration Area to the WTRU. The AMF sends the Registration Area information to the WTRU. The Registration Area information is a list of tracking areas for the WTRU. The list of tracking areas is a tracking area identity (TAI) list.

A TA is a logical concept where WTRU can move without updating the network about its location. The TAI is constructed from the Mobile Country Code (MCC), Mobile Network Code (MNC) and Tracking Area Code (TAC). One or more base stations can be part of the same TA. Each base station this is part of the same TA broadcasts the same TAI. Further, the WTRU performs a mobility registration update when the WTRU moves to a TA that is outside the WTRU's registration area.

As used in embodiments and examples provided herein, an RA set is a new term defined herein. An RA set is a logical grouping of one or more RAs that are determined by the network and provided to a WTRU to enable dynamic registration update behavior. An RA set has an RA set identifier and all RAs of the RA set share the same RA set identifier. In an example, an RA set may also be referred to as an RA superset. Moreover, an RA set may also be referred to as an RA subset, in an example.

As used in embodiments and examples provided herein, a RAN node or an access network (AN) node, includes a base station, eNodeB, gNodeB and the like. Further, registration request and registration accept are examples of NAS-mobility management (MM) messages. Registration is an example of a NAS-MM procedure. This paper proposes enhancements to the registration procedure, Registration Request message and Registration Accept messages. The ideas, apparatus and methods provided herein could be used in any NAS-MM procedure and NAS-MM message.

Embodiments and examples provided herein include optimization of how the WTRU determines to indicate to the network that the WTRU has moved from a tracking area of a first Registration Area to a tracking area of a second Registration Area. It should be understood that the ideas could apply to how the WTRU determines to indicate to the network that the WTRU has moved from a first location to a second location. The first and second location can each be described as a geographical area, a topological area, a list of cells, a list of base stations, or a list of tracking areas.

As used in embodiments and examples provided herein, paging resources refer to the number of cells that a paging indication is transmitted over, the power with which a paging indication is transmitted, the duration of the paging indication transmission, the number of times that the paging indication is transmitted, and the like.

There are advantages to configuring a WTRU with a relatively large RA. For example, an advantage to configuring a WTRU with a large RA is that, when the WTRU is in Idle mode, the WTRU can be mobile within the large RA and the WTRU would not have to trigger a Registration Update Procedure until the WTRU's Registration Update timer expires. Thus, signaling and WTRU power consumption is reduced.

However, there are disadvantages to configuring a WTRU with a relatively large Registration Area. For example, a WTRU in idle mode with a large Registration Area consumes a large amount of the network paging resources when the network needs to page the WTRU over the large RA. In other words, many base stations will have to broadcast the paging message to reach the idle WTRU since the network does not know the TA where the WTRU is camped, and the network will have to transmit the paging indication over all TAs (e.g., base stations) of the large RA. On the other hand, if the network can tolerate a long response delay, the network could page the WTRU over a few TAs at a time until a response is received. Thus, the network is forced to choose between possibly accepting a long response delay and/or consuming a lot of paging resources.

Also, there are advantages to configuring a WTRU with a relatively small RA. For example, an advantage to configuring a WTRU with a small RA is that, when the WTRU is in Idle mode, the network knows the WTRU's location with greater accuracy and fewer paging resources are needed to successfully page the WTRU due to the small RA. If the network determined that the WTRU needs to be paged quickly, then the network would only have to broadcast the paging indication over a small RA.

Yet, there are disadvantages to configuring a WTRU with a relatively small RA. For example, a disadvantage to configuring a WTRU with a small RA is that, when the WTRU is in Idle mode and the WTRU is mobile, it is more likely that the WTRU will leave the RA. Leaving the Registration area will result in the WTRU triggering a mobility Registration Update procedure. A Registration Update procedure results in network signaling and WTRU power consumption.

Determining an optimal RA for a WTRU may be dependent on characteristics such as the WTRU mobility, the energy availability in the WTRU to perform Registration Update procedures, the capability to perform triggering paging messages, and/or the radio resources availability and WTRU density in certain areas. In 5^{th} Generation (5G) systems, the RA is determined by the AMF. Importantly, the WTRU has no influence over the size of the RA. The AMF may determine an RA based on analytics information, subscription information, provisioned information, or observations of previous WTRU behavior and traffic types. WTRU behavior refers to the mobility behavior (e.g. location and speed) and how often the WTRU initiates a transition out of IDLE mode to send uplink application layer traffic.

Accordingly, there is a need to improve WTRU tracking and reachability in the network by improving how the WTRU and network coordinate, as well as whether and when RA updates are needed. Embodiments and examples provided herein address that need.

Embodiments and examples provided herein include solutions which allow a network to provision a WTRU with an RA set to enable a WTRU to dynamically adapt its registration update behavior. In an example, an AMF allocates a set of registration areas (e.g., a RA set) to a WTRU such that a WTRU can dynamically determine whether and when to trigger a mobility registration update towards the network. Additionally or alternatively, a WTRU determines, based on the RA set information, to trigger a registration update and may trigger a mobility registration update when it moves out of a first registration area of an RA set, but may determine that a mobility registration update is not needed when the WTRU moves out of a second registration area of the same RA set.

Embodiments and examples provided herein include solutions which allow the WTRU to dynamically change which registration area is considered by the WTRU when determining whether to trigger a mobility registration update procedure. In the solution, the AMF allocates a set of registration areas to the WTRU. The set of registration areas is called RA set. Each registration area within a RA set can be assigned an identifier (e.g., numbered 1 through N) and be may be uniquely identified using this identifier within the RA set. The WTRU can consider the RA set to determine which registration area is used to trigger a mobility registration update.

For example, the WTRU may determine to trigger a mobility registration update whenever it moves out of a first registration area of the RA set, but may determine that a mobility registration update does not need to be triggered when the WTRU moves out of a second registration area of the RA set.

Additionally or alternatively, the WTRU may determine what registration area(s) should be used to trigger a registration area update based on the registration area size and the power level of the WTRU. For example, when the WTRU battery level is low, the WTRU may determine to save power by reducing the signaling for mobility registration updates, and to only trigger a mobility registration update when the WTRU moves out of a larger registration area.

The WTRU may make the determination of what registration area(s) should be used to trigger a registration area update based on information that is broadcasted by a base station. For example, when a base station broadcasts the identity of what registration area should be used to trigger a registration area update. For example, during a time where there is a relatively large number of WTRUs connected to a base station or connected to a tracking area, the network may determine to broadcast that a larger registration area should be used to trigger mobility registration update procedures. The network may prefer a larger registration area in order to reduce the amount of signaling that is needed between the WTRUs and network. Additionally or alternatively, the network may prefer a smaller registration area in order to conserve paging resources in the network.

Embodiments and examples provided herein include how a WTRU can be configured with registration area set during registration. Also, embodiments and examples provided herein include how the WTRU selects an active registration area. Further, embodiments and examples provided herein include how the WTRU uses the active registration area to determine whether to trigger a mobility registration procedure. Moreover, embodiments and examples provided herein include how the network might update the registration area set.

The term “active registration area” is used in embodiments and examples provided herein to refer to the current registration area within a “registration area set” that the WTRU uses to determine whether or not to trigger a mobility registration update procedure.

In an example, a WTRU sends a request message to an AMF. Additionally or alternatively, the request message may be a registration request message which is an NAS-MM message. Additionally or alternatively, the request message indicates that the WTRU supports receiving an RA set.

The WTRU receives a response message that includes RA set information. The RA set Information includes information about two or more RA's and each RA is associated with one or more tracking area identities. Additionally or alternatively, each RA is associated with one RA Identity. Additionally or alternatively, each RA is associated with a probability value.

Further, the WTRU detects that the WTRU has moved from a first TA to a second TA. Also, the WTRU determines that the first TA and second TA are both part of the RA set but are not both part of the same RA.

Additionally, the WTRU determines to send a second request message to the AMF. The determination may be based on a condition. For example, the determination may be based on a condition that the first TA and second TA are not part of the same RA.

Additionally or alternatively, the condition may be that the second TA is associated with a power mode setting of the WTRU. Additionally or alternatively, the condition may be that the second TA is associated with a discontinuous reception (DRX) cycle size configuration of the WTRU.

Additionally or alternatively, the condition may be that the second TA is associated an RA Identity that is broadcasted by the network. Additionally or alternatively, the condition may be that the second TA is not associated an RA Identity that is broadcasted by the network.

Additionally or alternatively, the condition may be that the second TA is associated with a probability value that is broadcasted by the network. Additionally or alternatively, the condition may be that the second TA is associated with a probability value that is less than a probability value that is broadcasted by the network. Additionally or alternatively, the.

Additionally or alternatively, the condition may be that a policy received by the WTRU indicates that the WTRU should trigger a mobility registration update when the WTRU moves to the second TA. Additionally or alternatively, the policy may be received by the WTRU in policy information.

Further, the WTRU sends a registration update request message to the AMF. Moreover, the WTRU receives a second response message.

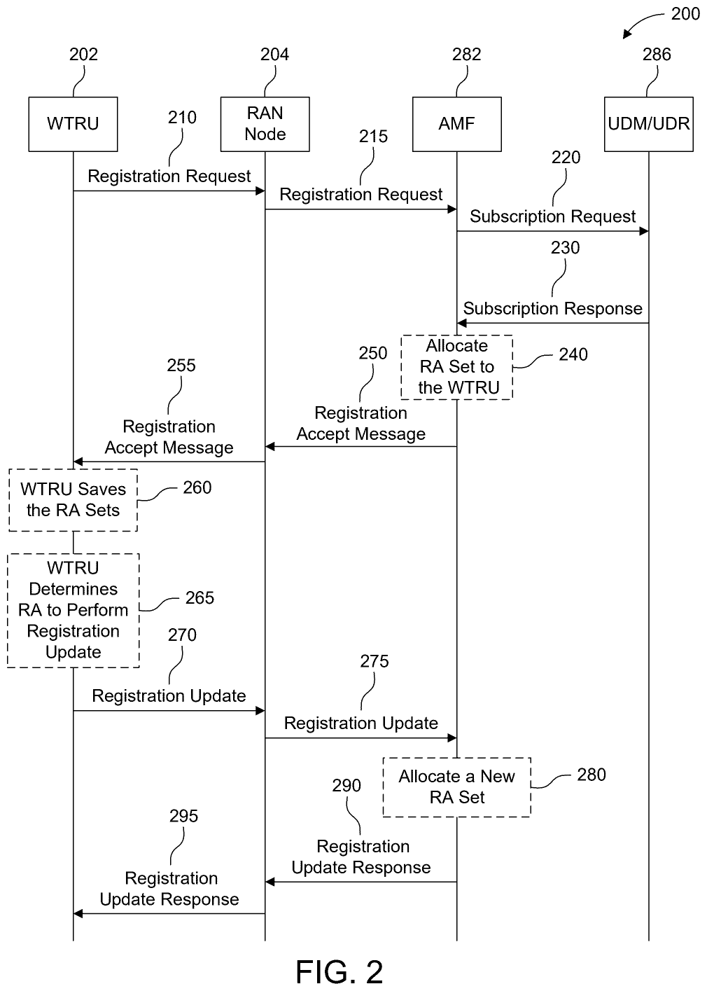

FIG. 2 is a system diagram illustrating an example procedure of a WTRU configured and triggered to update an RA set and a network response. Examples shown in system diagram 200 include RA set configuration and usability. FIG. 2 includes WTRU 202. In an example, WTRU 202 may be the same as or similar to WTRU 102.

As shown in FIG. 2, the WTRU 202 sends a registration request message 210 towards the AN. For example, the WTRU 202 may send the registration request message 210 towards RAN node 204. In an example, RAN node 204 may be the same as, may be similar to, or may be located within base station 114a. The registration request message 210 has the identity of the WTRU. The message might have an indication that the WTRU can be configured with RA set. A Registration Request is one example of NAS message that may be used to send the WTRU's registration request and RA set support indication. Other types of NAS messages may be used to send this information. For example, an UL NAS Transport Message may be used to send this information.

The AN, such as RAN node 204, may send or forward registration request message 215 to an AMF 282. In an example, AMF 282 may be the same as or similar to AMF 182b.

Upon receiving the registration request message 215 from the AN, the AMF 282 sends a subscription data request 220 to a UDM/UDR 286. The request 220 may include the set support indication from the WTRU 202. The UDM/UDR 286 may consider the received set support indication and/or pre-determined subscription information to determine if an RA set should be sent to the WTRU 202 and the rules for selecting an RA set area for the WTRU 202.

Further, the AMF 282 receives the device's subscription data from the UDM/UDR 286 in a subscription response message 230. The subscription data may indicate the rules to select the subscription RA set for the WTRU 202. The rules might include or consider the device type, device privileges, and applications associated with the device.

Additionally or alternatively, further steps may be included involving the registration request message 215 and subscription response message 230 between the AMF 282 and UDM/UDR 286. For example, upon receiving the request from the AN, the AMF 282 sends subscription data request to the UDM/UDR 286, the request may include the set support indication from the WTRU. The UDM/UDR 286 may provide subscription data that includes: an indication whether the WTRU's subscription allows RA sets; RA set assistance information; and the like. The RA set assistance information may include device type, device privileges, applications associated with the device, device mobility patterns, application traffic patterns (e.g., AS traffic to WTRU very frequent or infrequent).

As another example, the AMF 282 receives the device's subscription data from the UDM/UDR 286. The AMF 282 may be pre-configured with RA set rules to determine the RA set. The determination may be based on the received RA set assistance information.

Also, the AMF 282 allocates an RU Set 240 to the WTRU 202. For example, the AMF 282 determines whether to send a single RA to the WTRU 202 or whether to send an RA set to the WTRU 202. The AMF 282 may determine to send an RA set to the WTRU 202 if the WTRU 202 indicated in the Registration Request message 210 that the WTRU 202 supports receiving an RA set. The AMF 282 may determine to send an RA set to the WTRU 202 if the subscription information 230 that was received from the UDM/UDR 286 indicated that an RA set should be sent to the WTRU 202 and/or indicated RA set determination rules. The AMF 282 may determine to send an RA set to the WTRU 202 if the subscription information 230 that was received from the UDM/UDR 286 indicated that an RA set should be sent to the WTRU 202, indicated RA set determination rules, and/or indicated whether the WTRU's subscription allows RA sets, and/or RA set assistance information.

The AMF 282 may use data analytics from a network data analytics function (NWDAF) to determine an RA set. Determining the RA set means determining which tracking area(s) to include in each RA of the RA set. For example, data analytics used to determine an RA set may be based on historical or predicted mobility patterns of the WTRU received from an NWDAF and/or may be based on subscription information received from the UDM/UDR 286 in subscription response 230.

The AMF 282 may, for example, build an RA set that includes three registration areas. The first registration area may include only Tracking Areas where the WTRU has a greater than 75% probability to be located. The second registration area may include only Tracking Areas where the WTRU has a greater than 50% probability to be located. The third registration area may include only Tracking Areas where the WTRU has a greater than 25% probability to be located. Thus, all the tracking areas that are included in the third registration area may also be included in the second registration area and included in the first registration area. Thus, all the tracking areas that are included in the second registration area may also be included in the in the first registration area. It should be appreciated that it is not required that all the tracking areas that are included in the third registration area are also be included in the second registration area and included in the first registration area. Also, it is not required that all the tracking areas that are included in the second registration area are also be included in the first registration area.

In addition, the AMF 282 sends a Registration Response, such as in registration accept message 250, to the AN, such as RAN node 204. The Registration Response 250 includes the RA set Information. Each RA in the set may be associated with an identifier (e.g., a number). The RAs included in the RA set information may be associated with RA information. Each RA information may be associated with: an RA identifier; a probability value that represents the probability that the AMF calculated that WTRU would be in a RA; and a list of Tracking Area Identifiers that are associated with the RA.

The AN, such as RAN node 204, forwards the registration accept message 255 to the WTRU 202. The message 255 may be sent to the WTRU 202, by the AN, in a radio resource control (RRC) message.

Further, the WTRU 202 receives the registration accept message 255. Also, the WTRU 202 saves the RA set information 260.

Moreover, the WTRU determines to perform a mobility registration update. For example, the WTRU determines the RA to use in performing a registration update 265.

When the WTRU moves from a first TA to a second TA, the WTRU may determine if a mobility registration update procedure should be triggered. If the second TA is not part of the RA set, the WTRU may determine to trigger the mobility registration update procedure.

If the first TA and the second TA are part of the same RA, the WTRU may determine to not trigger the mobility registration update procedure. If the first TA and second TA are both part of the RA set but not part of the same RA, then the WTRU will determine whether a mobility registration update procedure should be triggered.

In a first example, the determination may be based on power mode preference setting in the WTRU 202. For example, the WTRU 202 may host a graphical user interface (GUI) that allows the user to configure different power modes (e.g. low, medium, and high). The power mode may indicate a preference to conserve power or a determination of a low amount of power available. In this example, when the power mode preference is set to low, the WTRU 202 may choose to only Initiate a Mobility Registration Update procedure when the WTRU 202 leaves the Registration Area set. Thus, signaling may be reduced when the WTRU 202 is in a low power mode. In this example, when the power mode is set to high, the WTRU 202 may choose to Initiate a Registration Area Update procedure each time the WTRU 202 moves between RAs of the RA set. Thus, when the WTRU 202 is operating in high power mode, signaling may be increased but the network would be able to estimate the WTRU's location more accurately. In this example, when the power mode is set to medium, the WTRU may determine to only trigger a mobility registration update when the WTRU moves between certain RAs. For example, the WTRU may use the probability value to determine whether to trigger the mobility registration update procedure. For example, when operating in medium power mode, the WTRU may determine to trigger the mobility registration update procedure only if the WTRU moves to a location where the network calculated that the WTRU is likely to be located with 25% probability.

In a second example, the determination may be based on DRX Setting of the WTRU. The WTRU may infer that it is in a low power mode and that the WTRU's applications can tolerate a relatively long paging delay if the WTRU's DRX Cycle is very long. The WTRU may infer that it is in a high-power mode and that the WTRU's applications can not tolerate a relatively long paging delay if the WTRU's DRX Cycle is very short. The WTRU may infer that it is in a medium power mode if the WTRU's DRX Cycle is greater than a first value and less than a second value.

In a third example, the WTRU may use assistance information that is broadcasted by the RAN to determine to trigger a mobility registration update procedure when the WTRU moves from a first TA to a second TA, and both TAs are part of the RA set but not part of the same RA. For example, the assistance information may include an RA Identity. The WTRU may interpret the RA Identity in the broadcast information as an indication that the WTRU should only trigger a mobility registration update procedure when the WTRU leaves the identified RA. An advantage of this approach is that the network can control which RA is used to trigger mobility registration updates and the network can have this control even while the WTRU is in IDLE mode.

Additionally or alternatively to the third example, the WTRU may interpret the RA Identity in the broadcast information as an indication that the WTRU should not trigger a mobility registration update procedure when the WTRU leaves the identified RA.

Additionally or alternatively to the third example, the WTRU may interpret the RA Identity in the broadcast information as an indication that the WTRU should trigger a mobility registration update procedure when the WTRU leaves an RA whose identity is less than or equal to the RA Identity in the broadcast information.

Additionally or alternatively to the third example, the WTRU may interpret the RA Identity in the broadcast information as an indication that the WTRU should trigger a mobility registration update procedure when the WTRU leaves an RA whose identity is greater than or equal to the RA Identity in the broadcast information.

In a fourth example, the WTRU may use assistance information that is broadcasted by the AN to determine whether to trigger a mobility registration update procedure when the WTRU moves from a first TA and a second TA and both TAs are part of the RA set but not part of the same RA. For example, the assistance information may indicate a probability value. The WTRU may interpret the probability value in the broadcast information as an indication that the WTRU should only trigger a mobility registration update procedure when the WTRU moves to an RA whose associated probability is less than or equal to the broadcasted probability value. The probability that is associated the RA is the probability value that the WTRU received in the registration accept message 255. An advantage of this approach is that the network can control which RA(s) are used to trigger mobility registration updates and the network can have this control even while the WTRU is in IDLE mode.

In a fifth example, the user may use a GUI to provide an indication to the WTRU relative to when the mobility update procedure should be triggered. For example, the user may indicate to WTRU to trigger a mobility registration update. For example, the user indication may indicate to trigger a mobility registration update upon a change of RA, upon a change to a RA not included in a RA set, upon a change of RA within an RA set, upon a change of TA, upon a change of TA not included in a RA set, and/or upon a change of RA within a RA set.

In a sixth example, the WTRU may use assistance information that is broadcasted by the AN to determine whether to trigger a mobility registration update procedure when the WTRU moves from first TA and second TA and both TAs are part of the RA set but not part of the same RA. This assistance information may be an indication that tells the WTRU to trigger a mobility registration update. For example, the assistance information may indicate to trigger a registration mobility update.

For example, the network may determine to limit mobility registration updates based on network congestion, WTRU density, and the like. The assistance information that is broadcasted by the network can be broadcasted in a system information message (for example as part of a SIB).

These examples to determine whether the WTRU should trigger a mobility registration update may be used in combination, and the determination may be additionally conditioned on other factors. For example, some of these factors may include if the WTRU power is below (or above) a configured threshold, if WTRU is moving or stationary, if WTRU is moving below (or above) a certain configured speed, if WTRU is moving in a certain direction, and the like.

Upon making the determination of initiating the mobility registration update procedure, the WTRU 202 sends a registration update request 270 to the AN, such as RAN node 204. Upon receiving the registration update request message 270 from the WTRU 202, the AN, such as RAN node 204, sends the registration update request message 275 to the AMF 282.

Upon receiving the registration update request message 275 from the AN, the AMF 282 may determine a new RA set for the WTRU 202. Accordingly, the AMF 282 may allocate a new RA set 280 for the WTRU 202. This allocation 260 may be the same as or similar to allocation 240.

Further, the AMF 282 sends a registration update response message 290 to the AN, such as RAN node 204. This registration update response message 290 is the same as or similar to the registration accept message 250.

Upon receiving the message 290 from the AMF 282, the AN sends the registration update response message 295 to the WTRU 202. This message is the same as or similar to the registration accept message 255.

Examples including selecting an RA for triggering a mobility registration update via a policy are provided herein. As explained in the determination 265, when the WTRU moves from a first RA of an RA set to a second RA of the same RA set, the WTRU needs to make a determination of whether a mobility registration update procedure should be triggered. The WTRU may be configured with a policy. The WTRU may receive the policy in an NAS-MM message such as a WTRU Configuration Update message or a WTRU Registration Accept message. In an example in the determination 265, the policy may be used by the WTRU to determine whether the WTRU's movement from the first RA to the second RA should trigger a mobility registration update procedure.

The policy may include Application Identifiers and RA Identifiers. The policy may indicate that each Application Identifier in the policy is associated with one or more RA Identifiers. The indication that an Application Identifier is associated with an RA Identifier is an indication to the WTRU that the WTRU should trigger a mobility registration update procedure when the WTRU is executing the application associated with the application identifier and enters a TA that is not part of the RA.

The Application Identifier may identify an application type. The Application Identifier may identify an application server that a WTRU application may connect to or communicate with.

The advantage of a policy that associates Applications with RA(s) is that the network can configure the WTRU to use relatively small RA(s) when the WTRU is running an application that requires a small paging delay or requires the network to know the WTRU's location with relatively greater certainty. Also, the network can configure the WTRU to use relatively larger RA(s) when the WTRU is not running any applications that require a small paging delay and is not running any application that require the network to know the WTRU's location with relatively greater certainty. If the WTRU is running multiple applications, this approach would result in the WTRU using the smallest RA that is required by any running application.

The policy may also indicate that the WTRU should trigger a mobility registration update when moving from a first RA to a second RA, but that the WTRU does not need to trigger a mobility registration update when moving from the second RA to the first RA. Providing this information to the WTRU may be advantageous because WTRU may be in the second RA when the WTRU sends the registration request, and the AMF may anticipate that the WTRU will soon move to the first RA and stay in the first RA for a period of time. The AMF may know to anticipate this WTRU's movement based on analytics information that was received from the AMF or anticipated trajectory information that the AMF received from the UDM/UDR.

The AMF may anticipate that, if the AMF needs to page the WTRU, the paging strategy of the network will involve initially transmitting the paging message in the first RA and not initially transmitting the paging message in the second RA. Thus, the policy may be used to configure the WTRU to trigger a mobility registration update if the WTRU moves from the second RA to the first RA, and back to the second RA. The network can therefore use the policy to configure the WTRU to trigger a mobility registration update if the WTRU leaves and returns to a RA. Since the WTRU's movement back to the second RA is contrary to the AMF's anticipation that the WTRU will stay in the first RA, triggering the mobility registration update would be helpful because the message would inform the network that the WTRU's trajectory has deviated from the anticipated trajectory.

The policy may also indicate that the WTRU should trigger a mobility registration update procedure when the WTRU moves from a first RA to a second RA during a time window. As explained herein, the AMF may have trajectory information or analytics information that can be used to anticipate the WTRU's location. The AMF may also anticipate that the WTRU will be in certain locations, such as, for example, an RA, during certain time windows.

The policy may be a policy that is used to configure the WTRU to determine when to trigger mobility management procedures such as registration area update.

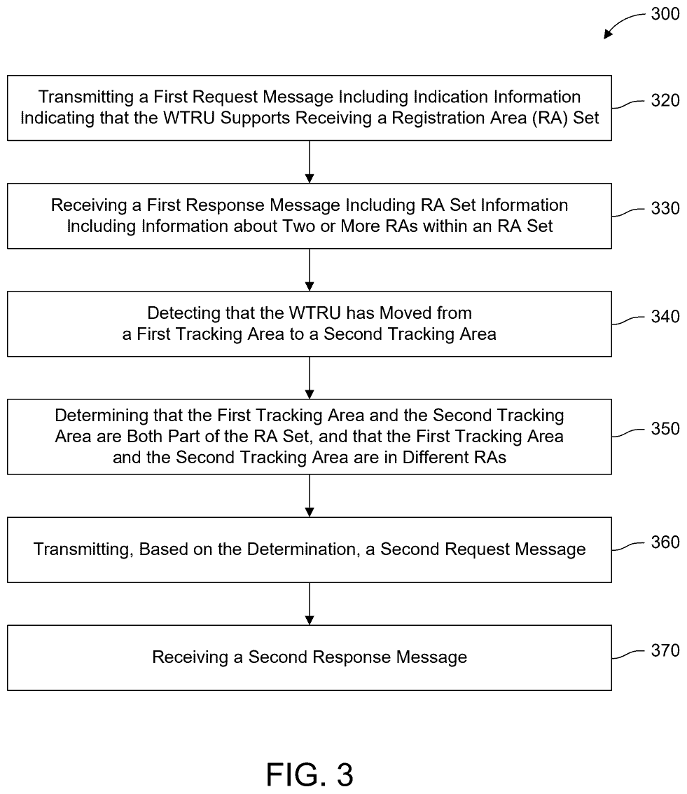

FIG. 3 is a flowchart diagram illustrating an example procedure of a WTRU updating an RA set and a network response. As shown in an example in flowchart diagram 300, a WTRU transmits a first request message including indication information indicating that the WTRU supports receiving an RA set 320. Further, the WTRU receives a first response message including RA set information, including information about two or more RAs within an RA set 330. In an example, each RA is associated with one or more tracking areas and a probability value. Additionally or alternatively, each tracking area is associated with a tracking area identity.

Also, the WTRU detects that the WTRU has moved from a first tracking area to a second tracking area 340. In addition, the WTRU determines that the first tracking area and the second tracking area are both part of the RA set, and that the first tracking area and the second tracking area are parts of different RAs 350. Further, the WTRU may also include in the determination that the second tracking area is part of an RA that is associated with a probability value that is less than a threshold.

The WTRU transmits, based on the determination, a second request message 360. Moreover, the WTRU receives a second response message 370.

Additionally or alternatively, each RA is associated with an RA Identity. Additionally or alternatively, the threshold is received from a network in a broadcast message.

Additionally or alternatively, the second request message is transmitted based on a further determination that the second tracking area is associated with a power mode setting of the WTRU. Additionally or alternatively, the second request message is transmitted based on a further determination that the second tracking area is associated with a DRX cycle size configuration of the WTRU.

Additionally or alternatively, the second request message is transmitted based on a further determination that the second tracking area is associated with an RA identity that is broadcast by the network. Additionally or alternatively, the second request message is transmitted based on a further determination that the second tracking area is not associated with an RA identity that is broadcast by the network.

Additionally or alternatively, the second request message is transmitted based on a further determination that second tracking area is associated with a probability value that is broadcast by the network. Additionally or alternatively, the second request message is transmitted based on a further determination that policy information received by the WTRU indicates that the WTRU should trigger a mobility registration update when the WTRU moves to the second tracking area. Additionally or alternatively, the first request message is a NAS-MM message.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit receive unit (WTRU), the method comprising:
transmitting a first request message including indication information that indicates the WTRU supports receiving a registration area (RA) set;
receiving a first response message including RA set information, wherein the RA set information includes information about two or more RAs within an RA set, wherein each RA is associated with one or more tracking areas and a probability value, wherein each tracking area is associated with a tracking area identity;
detecting that the WTRU has moved from a first tracking area to a second tracking area;
determining that the first tracking area and the second tracking area are both part of the RA set, that the first tracking area and the second tracking area are parts of different RAs, and that the second tracking area is part of an RA that is associated with a probability value that is less than a threshold;
transmitting, based on the determination, a second request message; and
receiving a second response message.

2. The method of claim 1, wherein each RA is associated with an RA Identity.

3. The method of claim 1, wherein the threshold is received from a network in a broadcast message.

4. The method of claim 1, wherein the second request message is transmitted based on a further determination that the second tracking area is associated with a power mode setting of the WTRU.

5. The method of claim 1, wherein the second request message is transmitted based on a further determination that the second tracking area is associated with a discontinuous reception (DRX) cycle size configuration of the WTRU.

6. The method of claim 1, wherein the second request message is transmitted based on a further determination that the second tracking area is associated with an RA identity that is broadcast by the network.

7. The method of claim 1, wherein the second request message is transmitted based on a further determination that the second tracking area is not associated with an RA identity that is broadcast by the network.

8. The method of claim 1, wherein the second request message is transmitted based on a further determination that second tracking area is associated with a probability value that is broadcast by the network.

9. The method of claim 1, wherein the second request message is transmitted based on a further determination that policy information received by the WTRU indicates that the WTRU should trigger a mobility registration update when the WTRU moves to the second tracking area.

10. The method of claim 1, wherein the first request message is a non-access-stratum mobility management (NAS-MM) message.

11. A wireless transmit receive unit (WTRU) comprising:
a transceiver operatively coupled to a processor, wherein the WTRU is configured to:
transmit a first request message including indication information that indicates the WTRU supports receiving a registration area (RA) set;
receive a first response message including RA set information, wherein the RA set information includes information about two or more RAs within an RA set, wherein each RA is associated with one or more tracking areas and a probability value, wherein each tracking area is associated with a tracking area identity;
detect that the WTRU has moved from a first tracking area to a second tracking area;
determine that the first tracking area and the second tracking area are both part of the RA set, that the first tracking area and the second tracking area are parts of different RAs, and that the second tracking area is part of an RA that is associated with a probability value that is less than a threshold;
transmit, based on the determination, a second request message; and
receive a second response message.

12. The WTRU of claim 11, wherein each RA is associated with an RA Identity.

13. The WTRU of claim 11, wherein the threshold is received from a network in a broadcast message.

14. The WTRU of claim 11, wherein the second request message is transmitted based on a further determination that the second tracking area is associated with a power mode setting of the WTRU.

15. The WTRU of claim 11, wherein the second request message is transmitted based on a further determination that the second tracking area is associated with a discontinuous reception (DRX) cycle size configuration of the WTRU.

16. The WTRU of claim 11, wherein the second request message is transmitted based on a further determination that the second tracking area is associated with an RA identity that is broadcast by the network.

17. The WTRU of claim 11, wherein the second request message is transmitted based on a further determination that the second tracking area is not associated with an RA identity that is broadcast by the network.

18. The WTRU of claim 11, wherein the second request message is transmitted based on a further determination that second tracking area is associated with a probability value that is broadcast by the network.

19. The WTRU of claim 11, wherein the second request message is transmitted based on a further determination that policy information received by the WTRU indicates that the WTRU should trigger a mobility registration update when the WTRU moves to the second tracking area.

20. The WTRU of claim 11, wherein the first request message is a non-access-stratum mobility management (NAS-MM) message.
